(19) United States
(12) Patent Application Publication
(10) Pub. No.: US 2007/0056218 A1
(43) Pub. Date: Mar. 15, 2007

(54) Window lifter for a motor vehicle

(76) Inventors: Frank Fassbender, Coburg (DE); Dalibor Rietdijk, Wetzlar (DE)

Correspondence Address: WHITE & CASE LLP;PATENT DEPARTMENT, 1155 AVENUE OF THE AMERICAS, NEW YORK, NY, 10036, US

(21) Appl. No.: 11/518,055

(22) Filed: Sep. 8, 2006

(30) Foreign Application Priority Data
Sep. 12, 2005 (DE) 20 2005 014 420.7

(51) Int. Cl. E05F 11/00

(52) U.S. Cl. 49/358

(57) ABSTRACT

A window lifter of a motor vehicle has a rail, a driver that is arranged displaceably on the rail, and to which a window pane can be fixed, a drive system fastened to the driver and configured for displacing the driver, a flat cable to which the drive system can be connected electrically, wherein the rail has a positioning means for positioning the flat cable.

### FIELD OF THE INVENTION

The invention relates to a window lifter of a motor vehicle.

### BACKGROUND OF THE INVENTION

Windows lifters that are driven by electric motors are used for displacing the window panes in motor vehicles between an open and a closed displacement position. Various window lifter mechanisms are known, such as cable window lifters or crossed arm window lifters. The drive is usually fixed in a motor-vehicle door and drives the displacement movement of the pane, for example, via a cable as the force transmission means. For guidance, the pane is fastened to one or more drivers which are arranged in a sliding manner on the rail. The rail is therefore also often referred to as a guide rail. The drive can likewise be fastened to the driver, with the result that the drive, which is stationary with respect to the window pane, is also displaced itself during a displacement of the window pane. In order to supply the drive with energy, the drive can be connected to the motor vehicle battery via electrical lines and switches.

### SUMMARY OF THE INVENTION

The invention is based on the object of specifying a window lifter that has an electrical connection that is as reliable as possible.

The invention is achieved by a window lifter of a motor vehicle having a rail, having a driver that is arranged displaceably on the rail and to which a window pane can be fixed, having a drive system that is fastened to the driver and is configured for displacing the driver, having a flat cable, to which the drive system can be connected electrically, in which the rail has a positioning means for positioning the flat cable. Advantageous developments include: (i) a positioning mechanism comprising a cable channel configured within the rail; (ii) a cable channel configured along a displacement direction; (iii) the flat cable opening at a plug-in connector that is fastened releasably to the rail; (iv) the plug-in connector being coupled on a rear side of the rail that faces away from at least one of the window pane and the driver; (v) the positioning mechanism comprising an opening in the rail, through which the opening of the flat cable is threaded; (vi) the threaded-through flat cable opening at the plug-in connector, the size of the opening being configured for threading through the plug-in connector; (vii) the opening in the rail being configured between an uppermost displacement position and a lowermost displacement position, preferably in a region around half of a displacement path; (viii) the positioning means comprising a web that positions the flat cable; (ix) the web holding down the flat cable in the cable channel; (x) the flat cable having a greater flexibility in a first bending direction than in a second bending direction; (xi) the flat cable being substantially S-shaped configuration; and (xii) the flat cable being fitted with electronic components and fixed on a cover of a housing in the fitting region.

Accordingly, a window lifter of a motor vehicle is provided with a rail, a driver and a drive system. The driver is arranged displaceably on the rail. A window pane can be fixed to the driver. Here, the drive system is fastened to the driver and is configured for displacing the driver. Here, parts, in particular gear mechanism parts, of the drive system and of the driver can be formed in one piece. The driver is advantageously arranged in a sliding or rolling manner on the rail and is guided by the rail.

The window lifter has a flat cable, to which the drive system can be connected electrically. As the drive system, which is fastened to the driver, is displaced with the driver, the flat cable is configured to be at least partially flexible. The rail has a positioning means for positioning the flat cable. The positioning means serves to position at least parts of the flat cable with regard to the position of the latter with respect to the rail, and to hold them in this position, at least over a part of a displacement stroke of the window lifter.

The flat conductor is, for example, an FPC (flexible printed circuit) or an extruded FFC (flexible flat cable) or the like. Here, the flat conductor advantageously has a preferential bending direction with a greater flexibility than other bending directions. The flat cable is preferably fitted with components of control electronics for controlling the displacement of the window lifter. For example, the existence of pinching can be detected and the displacement movement can be stopped by the control electronics.

In one preferred development, there is provision for the positioning means to have a cable channel that is configured within the rail. The flat cable that is arranged on the rail preferably has a greater flexibility in the direction of an opening of the cable channel than transversely with respect to the opening of the cable channel. Here, the cable channel preferably extends in the rail at least over a part of a displacement stroke of the window lifter in the displacement direction. In order to configure the cable channel, the rail is preferably configured at least partially from plastic.

There is preferably provision for the flat cable to open at a plug-in connector that is fastened preferably releasably to the rail. Here, the plug-in connector is advantageously sealed against moisture in a manner that is suitable for a wet space. Furthermore, the plug-in connector serves to position the flat cable on a rear side of the rail that faces away from the driver. The plug-in connector is therefore preferably fastened on this rear side of the rail which faces away from the window pane.

According to another development of the invention, there is provision for the positioning means to have an opening in the rail, through which opening the flat cable is threaded. Here, the opening is preferably configured between a front side of the rail, which faces the driver, and a rear side of the rail, which faces away from the driver. In addition, the opening is advantageously of elongate configuration, the length of the opening being configured substantially in the displacement direction.

In one refinement, the flat cable, which is threaded through the opening, opens at the plug-in connector. Here, the size of the opening is configured also for threading through the plug-in connector. For assembly, the flat conductor is advantageously inserted into the cable channel and, together with the plug-in connector, threaded through the opening in the rail. Subsequently, the plug-in connector is fastened on the rear side of the rail.

According to a further advantageous refinement, the opening in the rail is configured between an uppermost displacement position and a lowermost displacement position. The opening is preferably configured in a region around half of the displacement path. The length of the flat conductor is therefore preferably shorter than the displacement stroke of the window lifter.

The positioning means preferably has a web that positions the flat cable. The web is advantageously formed in one piece from plastic with the rail. Here, the web is preferably arranged in such a way that the web holds down the flat cable in the cable channel. The interaction of the positioning means preferably brings it about that the flat cable is arranged substantially in an S-shape.

### BRIEF DESCRIPTION OF THE DRAWINGS

In the following text, the invention will be explained in greater detail in an exemplary embodiment by using figures, in which:

FIG. 1 shows a three-dimensional view of a part of a window lifter;

FIG. 2 shows a three-dimensional rear view of a part of the window lifter; and

FIG. 3 shows a side view of a part of the window lifter.

### DETAILED DESCRIPTION

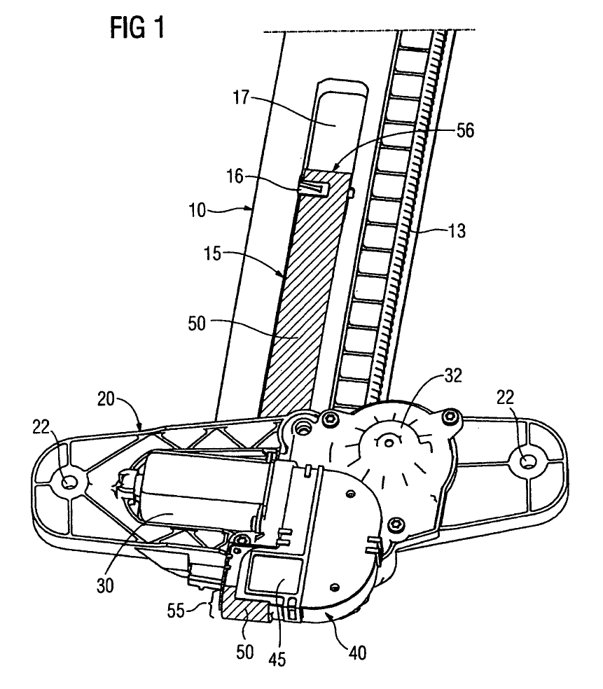

FIG. 1 shows the lower part of a window lifter in a three-dimensional view. The window lifter has a rail 10 and a driver 20 which is arranged displaceably on the rail 10. The driver 20 is guided on the rail 10. In FIG. 1, the driver 20 is shown in the lowermost displacement position. The driver 20 has fastening holes 22 for fastening a window pane, which is not shown in FIG. 1.

A drive system, which has an electric motor 30, a gear mechanism 32 and control electronics 40, is fastened on the driver 20. In order to displace the driver 20, an output pinion (not visible in FIG. 1) of the gear mechanism 32 meshes with a toothing system of the rail 10, which toothing system is configured as a rack 13. In the exemplary embodiment shown, the gear mechanism 32 is a worm gear mechanism that interacts with a drive shaft of the electric motor 30. The current through the electric motor 30 can be controlled by means of the control electronics 40. To this end, the electronics preferably have a power switch in the form of a relay or a power semiconductor. In addition, the control electronics can have further components, such as a microcontroller or driver blocks.

The control electronics are connected to the further motor vehicle electronics via a flat conductor 50 in the form of a flexible printed circuit (FPC). The supply current for the electric motor 30 is conducted via the flat conductor 50. In order to reinforce the flexible flat conductor 50 mechanically in the region, in which the components of the control electronics are fitted, the flat conductor 50 is fastened to a housing cover 45 of the control electronics 40 and is stiffened by said housing cover 45.

The shape of the flat conductor 50 is changed if the position of the driver 20 is displaced. The flat conductor 50 is arranged between the rail 10 and the driver 20 in approximately a displacement region between the lower stop and the opening 17 in the rail 10. This position reduces the risk of damage of the flat conductor 50 during transport before installation of the window lifter into a motor vehicle door.

The rail 10 has positioning means 15, 16, 17 that hold the flat conductor 50 in the desired position and shape. To this end, the rail 10 has a cable channel 15 that is open on the side of the driver 20. The flat conductor 50 is inserted into this cable channel 15. Here, the flat conductor 50 is of flexible configuration in such a way that the flat conductor 50 can be bent partially out of the cable channel 15 by the displacement of the driver 20. Bent regions are indicated as 55 and 56. In addition, a web 16 is preferably configured so as to be formed in one piece with the rail 10 in the vicinity of the opening 17. This web 16 acts as a hold-down that holds down the flat conductor 50 in the position of the web 16 in the cable channel 15, with the result that the flat conductor 50 cannot be bent out of the cable channel 15 in this region by the displacement of the driver 20.

The opening 17 makes it possible to thread the flat conductor 50 through, with the result that the flat conductor 50 can be moved from that side of the rail 10 that faces the driver 20 to that side of the rail 10 which faces away from the driver 10.

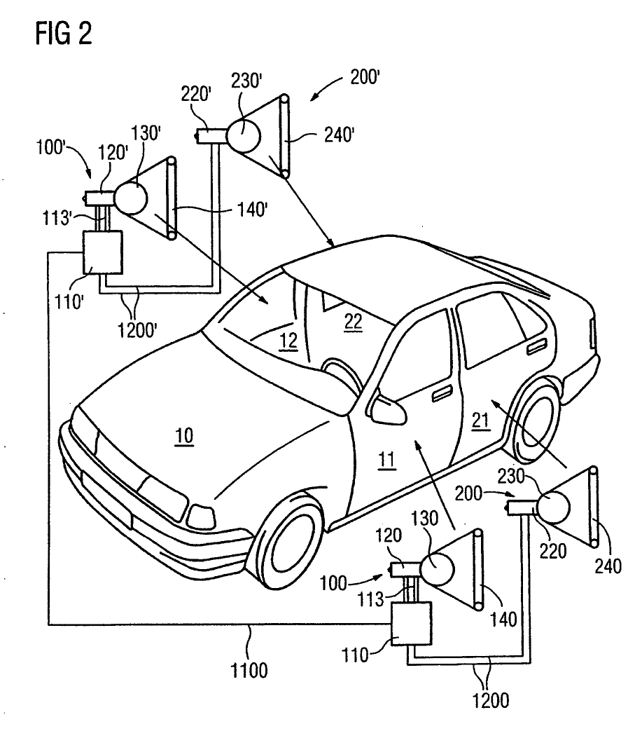

This rear side of the rail 10, which faces away from the driver 20, is shown in FIG. 2 in a three-dimensional view.

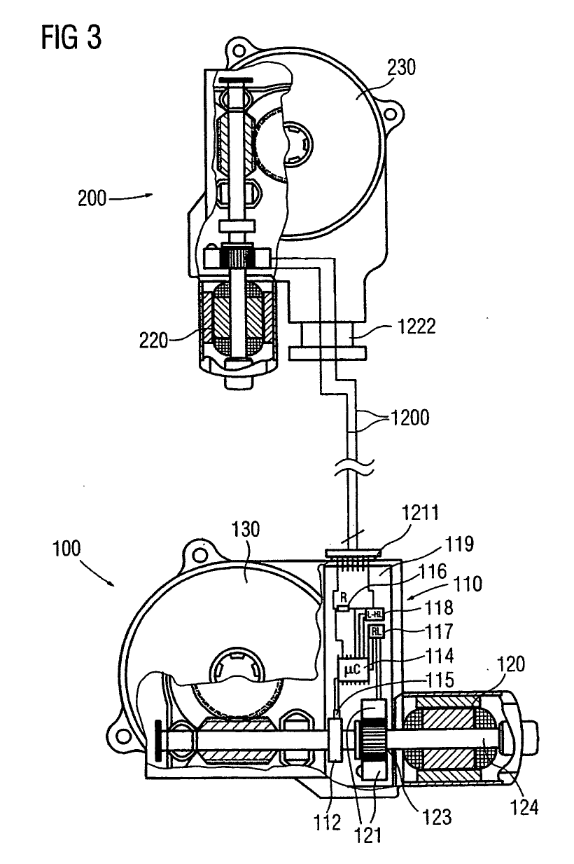

The rear view of the rail 10 shows a fastening point 11 for fastening the rail 10 within a motor vehicle door. Furthermore, the flat conductor 50 is threaded through the opening 17 in the rail 10. A receptacle 18 for fixing a plug-in connection (not shown in FIG. 2; 51 in FIG. 3) is provided for fastening the flat conductor 50 on the rear side of the rail 10. The plug-in connection (51) can be pushed onto the receptacle 18 and clipped.

FIG. 3 shows a side view of the lower part of the window lifter. A wet space plug 51, which is sealed against moisture, is pushed onto the receptacle 18. A complementary plug for connection to further electronics of the motor vehicle is not shown in FIG. 3. The flat conductor 50 opens into the wet space plug 51, the flat conductor 50 being fixed in the wet space plug 51. The flat conductor 50 is shown from the side in FIG. 3. The sections which are not visible and are covered by the rail 10 are indicated with dashed lines as flat conductor 50′.

The S-shaped configuration of the flat conductor 50, 50, as established by the positioning means 15, 16, 17 and 18 of the rail 10, has only two bending regions 55 and 56. Although the bending region 55 changes with the displacement of the driver 20 in its respective displacement position, the flat conductor 50 is bent in only one direction, with the result that no alternate bending occurs. In the displacement position of the driver 20, which is shown in FIG. 3, the flat conductor 50, 50′ is protected against damage as far as possible during transport of the window lifter. As a result of the arrangement of the flat cable 50, 50′, the window lifter can be configured as a compact structural unit having an integrated plug holder 18 and cable channel 15.

Incorporated by reference herein in their entirety are Germany priority application number 20 2005 014 420.7, filed Sep. 12, 2005, and its certified English language translation, copies of both of which documents are filed herewith.

What is claimed:

1. A window lifter for a motor vehicle, comprising:
a rail;
a driver arranged displaceably on the rail and to which the window can be coupled;
a drive system coupled to the driver and configured for displacing the driver; and
a flat cable, to which the drive system can be connected electrically;
wherein the rail comprises a positioning mechanism for positioning the flat cable.

2. The window lifter according to claim 1, in which the positioning mechanism comprises a cable channel configured within the rail.

3. The window lifter according to claim 2, in which the cable channel is configured along a displacement direction.

4. The window lifter according to claim 1, in which the flat cable opens at a plug-in connector that is fastened releasably to the rail.

5. The window lifter according to claim 4, in which the plug-in connector is coupled on a rear side of the rail that faces away from at least one of the window pane and the driver.

6. The window lifter according to claim 1, wherein the the positioning mechanism comprises an opening in the rail, through which the opening of the flat cable is threaded.

7. The window lifter according to claim 4, in which the threaded-through flat cable opens at the plug-in connector, the size of the opening being configured for threading through the plug-in connector.

8. The window lifter according to claim 6, in which the opening in the rail is configured between an uppermost displacement position and a lowermost displacement position, preferably in a region around half of a displacement path.

9. The window lifter according to claim 1, in which the positioning means comprises a web that positions the flat cable.

10. The window lifter according to claim 9, in which the web holds down the flat cable in the cable channel.

11. The window lifter according to claim 9, in which the flat cable has a greater flexibility in a first bending direction than in a second bending direction.

12. The window lifter according to claim 1, in which the flat cable is of substantially S-shaped configuration.

13. The window lifter according to claim 1, in which the flat cable is fitted with electronic components and is fixed on a cover of a housing in the fitting region.
